(19) United States
(12) Patent Application Publication
(10) Pub. No.: US 2008/0276094 A1
(43) Pub. Date: Nov. 6, 2008

(54) COMMUNICATION TERMINAL DEVICE, SERVER APPARATUS, DATA MANAGEMENT METHOD AND RECORDING MEDIUM

(75) Inventor: Minoru MAEDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/174,384

(22) Filed: Jul. 16, 2008

Related U.S. Application Data
(63) Continuation of application No. PCT/JP2006/300513, filed on Jan. 17, 2006.

(51) Int. Cl. H04L 9/00; G06F 15/16

(52) U.S. Cl. 713/176; 709/203

(57) ABSTRACT

A response is made to delivery data received by a communication terminal (cellular phone or the like) through a network (public network), the delivery data and the response action are traced and the delivery data during a predetermined time including the time at which the response action occurs and the data representing the response action are extracted, which is recorded as the traced data (TD). The traced data is transferred to a server device (signature server) through the network, and the data with the signature is transferred to the communication terminal and stored as the signed data.

### CROSS-REFERENCE TO RELATED APPLICATIONS

This application is a continuation of International Application No. PCT/JP2006/300513, filed on Jan. 17, 2006, now pending, herein incorporated by reference.

### BACKGROUND OF THE INVENTION

1. Field of the Invention

The present invention relates to data management such as data recording and authentication in data exchange via a network including a public network. Specifically, the present invention relates to a communication terminal device, a server apparatus, a data management system, a data management method, a data management program and a recording medium that are favorable to data management in being provided with service by using a browser function.

2. Description of the Related Art

Conventionally, a communication terminal device such as a cellular phone can be provided with pay service by a browser function via a network. Generally, when an offer and provision of service, a screen for a service offer is displayed, a contract and agreements are presented, and input such as key pushing is obliged. Input operation assigned to a determination key, etc. is necessary for consent and refusal for/against a contract and agreements thereof.

Concerning such service provision via a network, there are techniques such as; executing an electronic signature and encipherment as to an insurance contract system (Japanese Patent Application Laid-open Publication No. 2001-306811 (paragraph No. 0029, FIG. 1, etc.)); and storing contents of a contract based upon dealings among sites in a notarization database (Japanese Patent Application Laid-open Publication No. H10-275191 (paragraph Nos. 0009, 0013, FIGS. 1, 3, etc.), Japanese Patent Application Laid-open Publication No. 2002-197395 (paragraph Nos. 0009, 0013, FIGS. 1, 3, etc.)).

In service provision via a network, on a response and process to a contract or agreements displayed on a screen by a browser function, the contract or agreements are presented once in an offer thereof. However, even if there is difference between contents of service and what a user expects, it is troublesome to confirm or authenticate the contract or agreement.

There may be a case that display time about a contract and agreements sent from a service provider is shortened or decipherment thereabout is difficult. There also may be a case that toward a contract and agreements, a program is falsified into what is automatically consented and accepted only with a displayed screen without relationship to intention of a user. From these, it is possible to make an unconscionable contract.

The above described Japanese Patent Application Laid-open Publication Nos. 2001-306811, H10-275191 and 2002-197395 disclose creditability securement such as an electronic signature and store of notarization data. There is no disclosure or suggestion about the problem to secure the safety of service provision via a network. There is also no disclosure about structure to solve the problem or a conception thereof.

### SUMMARY OF THE INVENTION

An object of the present invention relates to data provided via a network, and is to realize recording and an authentication function of data including responses of a user.

Another object of the present invention relates to service provision via a network, and is to realize high data management that enhances recording and an authentication function of data including a contract and agreements.

To achieve the above object, a first aspect of the present invention there is provided a communication terminal device comprising: a display unit that displays delivery data of a network on a screen; an input unit that responds to the delivery data through a display screen on the display unit and generates response action thereof; a processing unit that traces the delivery data from the network and the response action, and extracts the delivery data of predetermined time including a time point at which the response action generates and data representing the response action; and a recording unit that records the data extracted by the processing unit.

According to such structure, delivery data displayed on the display unit and response action toward the delivery data are traced, and data which includes delivered data within the predetermined time including a generation time point of response action and data of the response action are extracted to be recorded in the recording unit. The recorded data can be provided as contents confirmation and authentication, etc. From the above structure, the object described above can be achieved.

According to the communication terminal device, preferably, the data recorded in the recording unit may include one or more than one of the delivery data, displayed images on the display unit, contents of the response action and time data thereof.

According to the communication terminal device, preferably, a browser function may be included to display a browser display screen on the display unit. Or, according to the communication terminal device, the response action may be generated by key operation of the input unit.

According to the communication terminal device, more preferably, an authentication function unit may be included to generate authentication data by tagging private key data on the data obtained in the processing unit. In such structure, tagged private key data is used for determination whether the data is falsified.

According to the communication terminal device, more preferably, a signed data storage unit may be included to store signed data notified from a server apparatus via the network. In such structure, signed data is stored in the signed data storage unit to be prevented from corrupting.

According to the communication terminal device, more preferably, a signed data storage unit that stores signed data notified from a server apparatus generating the signed data with tagging a signature on the data; and a check function unit that checks the signed data read out from the signed data storage unit and outputs the signed data may be included. In such structure, signed data stored in the communication terminal device can be checked to be output after the check.

According to the communication terminal device, the signed data may be enciphered with tagging key data and the signed data is checked by using the key data. In such structure, the reliability of signed data is maintained.

To achieve the above objects, a second aspect of the present invention there is provided a server apparatus that is connected with a communication terminal device via a network, the server apparatus comprising: an authentication function unit that authenticates whether data sent from the communication terminal device is true or not; and a signature function unit that tags a signature on the data in case where the data is true. According to such structure, the authentication function unit confirms whether data is true or not, the data which is an object that the communication terminal device requests the authentication function unit to authenticate. If true, the data is signed in the signature function unit.

According to the server apparatus, preferably, the authentication function unit may authenticate whether the data is true or not by using private key data; the data which is sent from the communication terminal device that transmits the data with tagging the private key data. Or, the signature function unit may tag key data on the data sent from the communication terminal device, and generates signed date with a signature.

To achieve the above objects, a third aspect of the present invention there is provided a data management method comprising the process of displaying delivery data of a network on a screen, responding the delivery data and generating response action thereof tracing the delivery data from the network and the response action, and extracting the delivery data within predetermined time including a time point at which the response action generates and data representing the response action; and recording the data.

According to such structure, delivery data displayed on the display unit and response action toward the delivery data are traced, and data having data delivered within the predetermined time including a generation time point of response action and data having the response action are extracted to be recorded in the recording unit. The recorded data can be provided as data management, e.g., contents confirmation and authentication thereof. From the above structure, the object described above can be achieved.

According to the data management method, the process may be comprised that authentication data is generated by tagging private key data on the data. Or, According to the data management method, the process may be comprised that signed data notified from a server apparatus is signed via the network.

According to the data management method, the process may be comprised that signed data notified from a server apparatus generating the signed data with tagging a signature on the data is stored; and the signed data is read out from a storing destination and after checking the signed data, the signed data is outputted.

To achieve the above objects, the data management method is a data management method of a server apparatus that is connected with a communication terminal device via a network, the method comprising the process of certifying whether data sent from the communication terminal device is true or not; and tagging a signature on the data in case where the data is true.

According to the data management method, preferably, the process may be comprised that whether the data is true or not is authenticated by using private key data; the data which is sent from the communication terminal device that transmits the data with tagging the private key data on. Or, preferably, the process may be comprised that key data is tagged on the data and signed data is generated with tagging a signature.

To achieve the above objects, the data management method is a data management method that is via a network, comprising the process of tracing delivery data of the network and response action thereof and, in response to the response action, recording the delivery data within predetermined time including a time point of the response action and data representing the response action to request a signature toward the data; and generating signed data toward the request of the signature. From such structure, the object described above can be achieved.

According to the data management method, the signature may be issued in case where the data is not falsified, that is, true data.

To achieve the above objects, a fourth aspect of the present invention there is provided a computer-readable recording medium storing a data management program, the program comprising the steps of displaying delivery data of a network on a screen, responding the delivery data and generating response action thereof, tracing the delivery data from the network and the response action, and extracting the delivery data for predetermined time including a time point at which the response action generates and data representing the response action; and recording the data.

According to such structure, delivery data displayed on a screen and response action toward the delivery data are traced, and data which includes delivered data within the predetermined time including a generation time point of response action and data of the response action are extracted to be recorded. The recorded data can be provided as contents confirmation and authentication thereof, etc. From the above structure, the object described above can be achieved.

According to the data management program, the step may be comprised that authentication data is generated by tagging private key data on the data. Or, according to the data management program, the step may be comprised that signed data notified from a server apparatus is stored via the network.

According to the data management program, the step may be comprised that signed data notified from a server apparatus generating the signed data with tagging a signature on the data is stored; and the signed data is read out from a storing destination and after checking the signed data, the signed data is outputted.

To achieve the above objects, the data management program is a data management program executed by a computer of a server apparatus that is connected with a communication terminal device via a network, the program comprising the steps of certifying whether data sent from the communication terminal device is true or not; and tagging a signature on the data in case where the data is true.

According to the data management program, the step may be comprised that whether the data is true or not is authenticated by using private key data; the data which is sent from the communication terminal device that transmits the data with tagging the private key data on. Or, according to the data management program, the step is comprised that key data is tagged on the data and signed data is generated with tagging a signature.

To achieve the above objects, the data management program is a data management program executed by a computer, the steps may be comprised that delivery data of a network and response action thereof are traced and, in response to the response action, the delivery data within predetermined time including a time point of the response action are recorded and data representing the response action to request a signature toward the data; and toward the request of the signature, the signed data is generated.

According to the data management program, the signature may be issued in case where the data is not falsified, that is, true data.

To achieve the above objects, a fifth aspect of the present invention there is provided a data management system using through the medium of a network, the system comprising: a communication terminal device that traces delivery data of the network and response action thereof, records the delivery data within predetermined time including a time point of the response action and data representing the response action in response to the response action, and requests a signature toward the data; and a server apparatus that toward the request of the signature from the communication terminal device, generates the signed data to return to the communication terminal device.

According to such structure, delivery data delivered from a network and displayed on the display unit and response action toward the delivery data are traced, and data which includes data delivered within the predetermined time including a time point of response action and data of the response action are extracted to be recorded in the communication terminal device. The recorded data is transferred from the communication terminal device to the server apparatus to generate data tagged a signature and returns to the communication terminal device. The signed data can be provided as contents confirmation and authentication thereof, etc. Thus, from the above structure, the object described above can be achieved.

The features and advantages of the present invention are as follows.

(1) Since data representing delivery data from a network and response action is recorded, the present invention can be provided as data management such as service provision from a network, recording response and confirmation.

(2) Authentication by a third party can be tagged on recorded data.

Other objects, features, and advantages of the present invention will be understood more clearly by referring to the embodiments and the accompanying drawings.

### BRIEF DESCRIPTION OF THE DRAWINGS

FIG. 1 depicts a data management system according to a first embodiment;

FIG. 2 depicts function structure of a cellular phone;

FIG. 3 depicts hardware of a cellular phone;

FIG. 4 depicts an outside of a cellular phone;

FIG. 5 depicts function structure of a signature server;

FIG. 6 depicts hardware of a signature server;

FIG. 7 depicts a data process sequence of a cellular phone and a server apparatus;

FIG. 8 is a flowchart showing process action of a cellular phone;

FIG. 9 is a flowchart showing process action of a signature server;

FIG. 10 is a flowchart showing process action of a cellular phone;

FIG. 11 depicts browser screen display and response action of a cellular phone;

FIG. 12 depicts hardware of a cellular phone according to a second embodiment;

FIG. 13 depicts a data management system according to a third embodiment; and

FIG. 14 depicts a data management system according to a fourth embodiment.

### DETAILED DESCRIPTION OF THE PREFERRED EMBODIMENTS

### First Embodiment

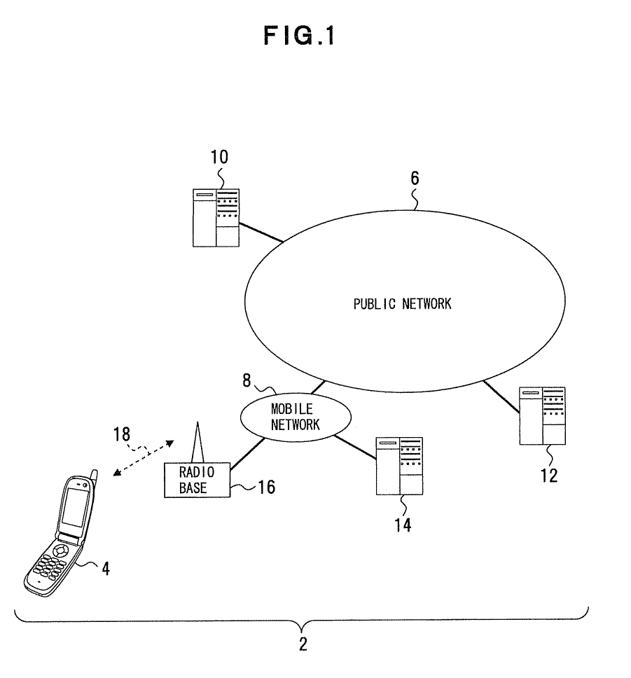

A first embodiment of the present invention will be described with reference to FIG. 1. FIG. 1 depicts a data management system according to a first embodiment.

In this data management system 2, for example, a cellular phone 4 as a communication terminal device receives service via a network such as a public network 6 or a mobile network 8. The public network 6 is a network operated by a public institution such as a communication corporation. The cellular phone 4 is, e.g., a Web (World Wide Web) client having a browser function. The browser function is a generic term for a web browser. The function enables a browse of data or a file delivered from the public network 6. The public network 6 is, for example, a communication line with premise of use of the general public. The network 6 is used in communication among computers such as the Internet. The mobile network 8 is a network which enables communication by, for example, a mobile via radio. To the public network 6, the mobile network 8 is connected along with a server providing pay service (hereinafter referred to as a service provision server) 10 and a server providing signature service (hereinafter referred to as a signature server) 12 as a server apparatus. To the mobile network 8, a server 14 as another server apparatus and a radio base 16 are connected. The cellular phone 4 as the above described communication terminal device is connected to the radio base 16 via a radio wave 18. A computer including a communication function, for example, composes the service provision server 10, the signature server 12 and the server 14. The communication terminal device linked with the service provision server 10 and the signature server 12, etc. via the public network 6 and the mobile network 8 may be a device having a communication function such as a Personal Digital Assistant (PDA) and a personal computer (PC) along with the cellular phone 4.

According to such structure, the cellular phone 4 can be provided with a variety of service from the service provision server 10 via a network, that is, the radio base 16, the mobile network 8 and the public network 6. The provided service is wide. For example, voice, images and contracts of sale of goods. If a user receives the service, a message image such as a contract and agreements delivered from the service provision server 10 is presented on a display screen of the cellular phone 4. In this case, the agreements do not have a form of a contract, but request a user to respond.

A user of the cellular phone 4 responds to contents on a browser image presented on the display screen of the cellular phone 4. The response is transmitted to the service provision server 10. That is, the contract is concluded and the user receives the service.

According to such data process, in response to a boot of a browser, data representing various action contents is stored in the cellular phone 4. The data is delivered images, displayed images thereof, a process with a network, inputs at the cellular phone 4, etc. The data is recorded within the predetermined time including the time point of input of response of the cellular phone 4. The recorded data is trace data.

Concerning the trace data, the cellular phone 4 requests signature process of the signature server 12. The signature server 12 returns the data as signed data to the cellular phone 4. The signed data can be treated as data with high reliability. The signature server 12 may be disposed at a public institution, a third party or a communication corporation providing service, etc. to be operated.

According to such structure, data representing a contract, etc. executed via the cellular phone 4 can be recorded and signed by the signature server 12, which is a third party. The structure can provide data management as powerful record and evidence of contents of a contract and agreements.

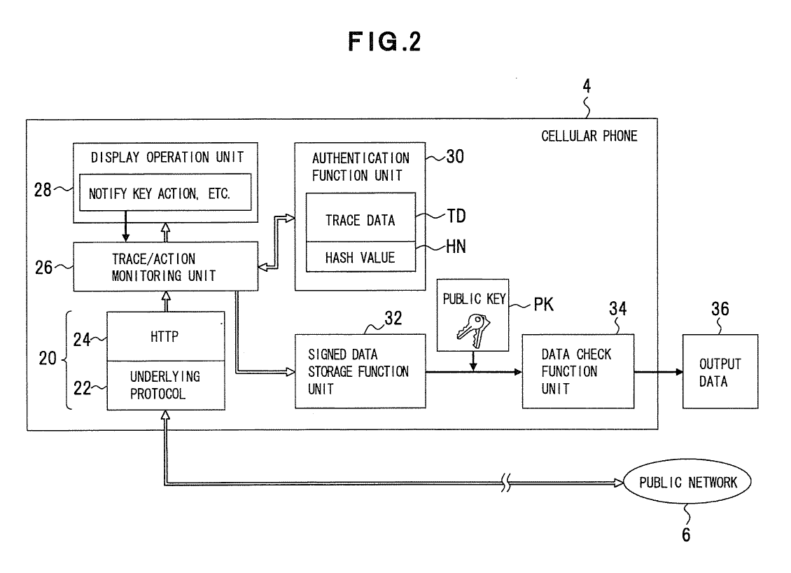

The communication terminal device will be described with reference to FIG. 2. FIG. 2 depicts function structure of the cellular phone 4. Same reference numerals are used in FIG. 2 for the same constituents in FIG. 1.

This cellular phone 4 transmits and receives various data such as image data via the public network 6 and an interface function unit 20. An underlying protocol 22 and HTTP (Hyper Text Transfer Protocol) 24, which is a high-level protocol, are set in the interface function unit 20. Data passing through the interface function unit 20 and a trace/action monitoring unit 26 enters a display operation unit 28. Thus, an image delivered from the public network 6 is displayed. According to the displayed image, in case displayed contents include contents needing a contract and agreements, key action such as an input key representing consent (or acceptance) or refusal in the display operation unit 28 returns data showing the action to the public network 6 via the trace/action monitoring unit 26 and the interface function unit 20.

The trace/action monitoring unit 26 is a processing unit monitoring a trace of data and response action. After the above described action of consent (or acceptance) or refusal, in response to the action, the unit 26 traces previous data that is transmit and received to/from the public network 6 and data representing contents of action of the display operation unit 28, stores the data as traced data TD and transfers the data to an authentication function unit 30.

The authentication function unit 30 tags private key data, for example, a hash value HN on the trace data TD as encipherment of the trace data TD, and obtains the enciphered trace data TD (authentication data). The trace data TD is sent from the trace/action monitoring unit 26 and the interface function unit 20 to the signature server 12. The signature server 12 executes a signature process in case the trace data TD is true. The signature server 12 obtains signed trace data sTD as signed data and transmits the data to the cellular phone 4. The enciphered trace data TD maintains confidentiality.

This signed trace data sTD is input from the public network 6 via the interface function unit 20 and the trace/action monitoring unit 26 to a signed data storage function unit 32, and stored.

In case the signed trace data sTD is output, key data provided by the signature server 12, for example, a public key PK is used. The data is checked in a data check function unit 34 and output data 36 is obtained. That is, this output data 36 is the signed trace data sTD and can be provided in case the trace data TD is requested as evidence, etc.

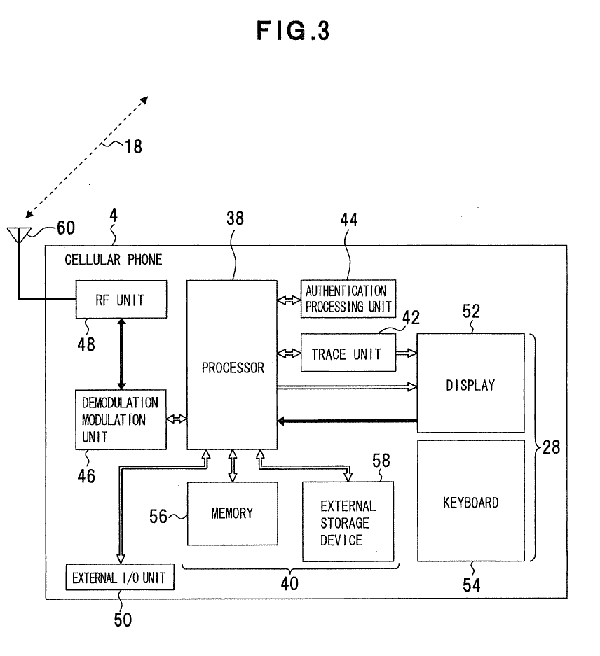

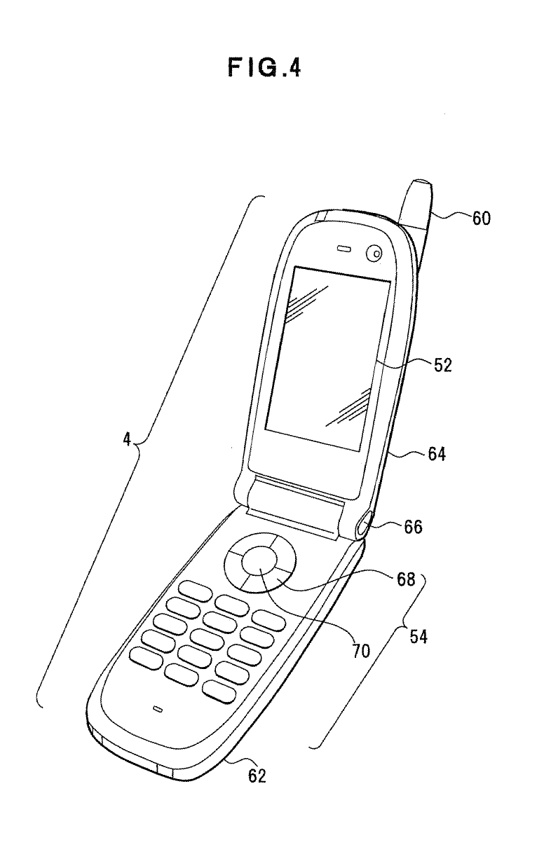

An exemplified hardware structure of the communication terminal device will be described with reference to FIGS. 3 and 4. FIG. 3 depicts hardware structure of the cellular phone 4 and FIG. 4 depicts an outside structure of the cellular phone 4. Same reference numerals are used in FIGS. 3 and 4 for the same constituents in FIGS. 1 and 2.

The cellular phone 4 includes the display operation unit 28, a processor 38, a storage unit 40, a trace unit 42, an authentication processing unit 44, a demodulation modulation unit 46, an RF (Radio Frequency) unit 48 and an external input and output (I/O) unit 50. The display operation unit 28 has a display 52 as a display unit, a keyboard 54 as an operation input unit, etc. The keyboard 54 includes an input key representing consent (or acceptance) or refusal as described above.

The processor 38 is a processing unit composed of an MPU (Micro Processing Unit), etc. The processor 38 also functions as the action monitoring unit described above, executes various programs stored in the storage unit 40, and executes various functions such as a communication function, a browser function, a data trace function, a action monitoring function, an encipherment function and a protocol function. The storage unit 40 is composed of a recording medium such as a memory 56 and an external storage device 58 that are made of ROM (Read-Only Memory) and RAM (Random-Access Memory) storing various programs such as a browser, data trace, and action monitoring. The unit 40 is used as store of the trace data TD and recording of the signed trace data sTD, etc., and composes a data recording unit. The memory 56 is used as store of the above described trace data TD, the hash value HN and signed data (the signed trace data sTD, etc.), and recording of the public key PK, etc. A hard disc or SIM (Subscriber Identify Module) card, etc. can be used for the external storage device 58.

The trace unit 42 composes the processing unit along with the processor 38, and corresponds to the trace/action monitoring unit 26. The authentication processing unit 44 corresponds to the authentication function unit 30, the signed data storage function unit 32 and the data check function unit 34, etc.

The demodulation modulation unit 46 is used for demodulation of data from a received signal or modulation of a carrier signal by using a signal representing data that should be sent. The RF unit 48 transmits and receives the radio wave 18 via an antenna 60.

The external I/O unit 50 is an output unit, for example, from which the output data 36 is extracted. And, the unit 50 is an input unit used as an input of data toward the processor 38, etc.

The cellular phone 4 is, as shown in FIG. 4, for example, composed of two housings 62 and 64 collapsible with a hinge 66. The housing 62 is disposed with the keyboard 54, etc. The housing 64 is disposed with the display 52, etc. Cursor keys 68 to operate a position of a cursor displayed in an image on the display 52 and a determination key 70 as the action key, etc. are disposed at the keyboard 54.

According to such structure, a variety of process can be executed such as exchange of data with the signature server 12 by using a communication function, store of the trace data TD representing action thereof, signature process of the trace data TD and extraction of the signed trace data sTD.

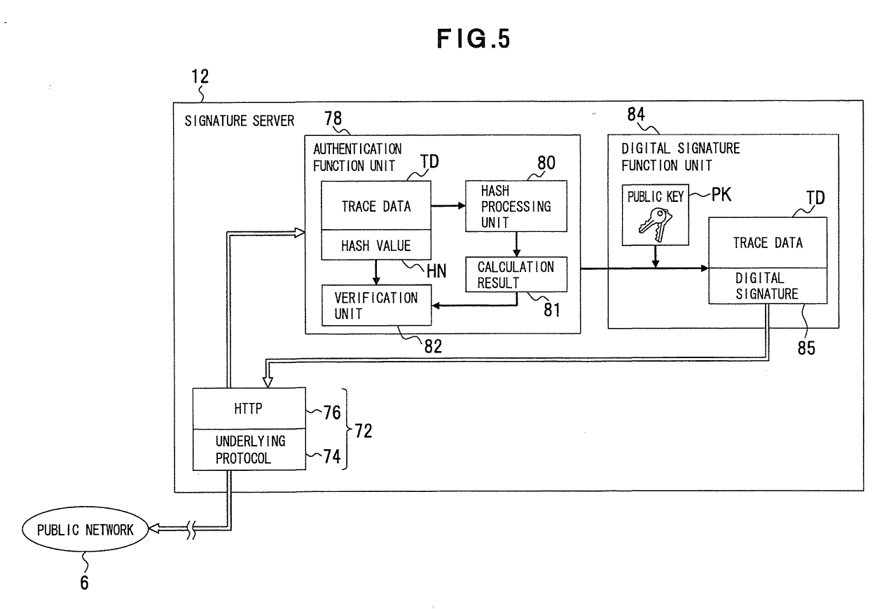

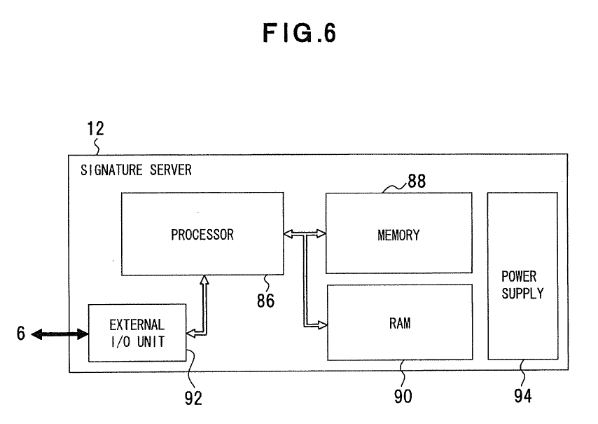

An exemplified structure of the server apparatus will be described with reference to FIGS. 5 and 6. FIG. 5 depicts function structure of the signature server 12 and FIG. 6 depicts hardware of the signature server 12.

This signature server 12 transmits and receives a variety of data via an interface function unit 72. In the interface function unit 72, an underlying protocol 74 and HTTP (Hyper Text Transfer Protocol) 76, which is a high-level protocol, are set. Data passing through the interface function unit 72 is taken into an authentication function unit 78.

In the authentication function unit 78, hash process (decoding process) is executed in a hash processing unit 80 toward the trace data TD authenticated at the cellular phone 4. The hash value HN is extracted in a calculation result 81 of the hash process. Comparing process between the hash value HN and a value transferred from the cellular phone 4 is executed in a verification unit 82. The comparing process is a process confirming whether the trace data TD is falsified or not. In case the trace data TD is not falsified, the trace data TD is sent to a digital signature function unit 84. In the digital signature function unit 84, the trace data TD is enciphered by the public key PK, and a digital signature 85 is tagged on the trace data TD to generate the signed trace data sTD. The signed trace data sTD is sent from the digital signature function unit 84 to the cellular phone 4 via the interface function unit 72. Since enciphered, the signed trace data sTD maintains confidentiality.

The signature server 12 is composed of a computer. As shown in FIG. 6, the signature server 12 is composed of a processor 86, a memory 88, RAM 90, an external input and output (I/O) unit 92, a power supply 94, etc.

The processor 86 executes various programs such as a communication function, an authentication function and a digital signature function, etc. with using programs stored in the memory 88. The processor 86 also executes writing into and reading out from data toward the RAM 90. The memory 88 stores a control program, etc. and is composed of a recording medium such as ROM and RAM. The RAM 90 is used as temporal store of data such as the trace data TD that is in the process.

The external I/O unit 92 is, for example, connected to the public network 6 via LAN (Local Area Network) and transmits and receives data to/from the cellular phone 4. The power supply 94 supplies power to various function units such as the processor 86.

According to such structure, true or false of the trace data TD sent from the cellular phone 4 can be confirmed by the hash value HN. The true trace data TD can be tagged on a digital signature, and be sent to the cellular phone 4.

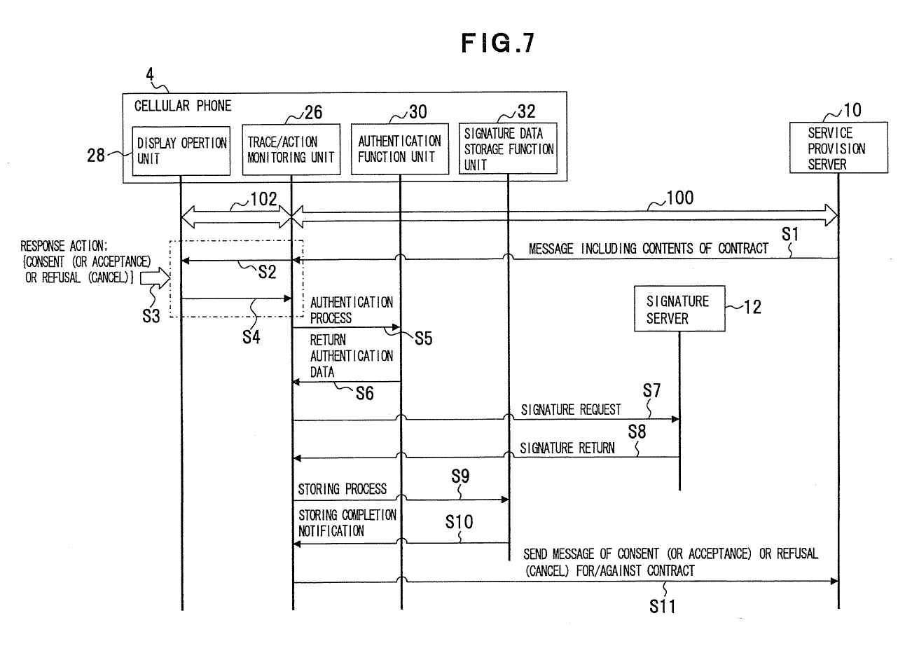

Data process (exchange) between the communication terminal device and the network will be described with reference to FIG. 7. FIG. 7 depicts a data process sequence of the cellular phone 4, the service provision server 10 and the signature server 12. Same reference numerals are used in FIG. 7 for the same constituents in FIG. 1 or 2.

This sequence shows that service including a contract and agreements is provided from the service provision server 10, and as to the contents of exchange in case of acceptance or refusal of the service provision, a signature is received from the signature server 12.

This exchange includes an exchange process 100 between the trace/action monitoring unit 26 of the cellular phone 4 and the service provision server 10 and an exchange process 102 between the trace/action monitoring unit 26 and the display operation unit 28. These exchange processes 100 and 102 include the process as follows.

(1) Establishment of communication between the cellular phone 4 and the service provision server 10

(2) Delivery of data representing service from the service provision server 10
(3) Trace and monitoring of delivery data by the trace/action monitoring unit 26
(4) Display to the display 52 of the display operation unit 28 (FIG. 3)
(5) Trace and monitoring of response action of a user to displayed contents and consent (or acceptance) or refusal (cancel) toward a message including a contract or agreements, etc. by the trace/action monitoring unit 26
(6) Sending data representing response action to the service provision server 10

By such exchange, acceptance or refusal (cancel), etc. of service provision from the service provision server 10 is executed.

According to such exchange, if a message including contents of a contract such as a contract and agreements is sent from the service provision server 10 (step S1), the message is traced and monitored at the trace/action monitoring unit 26 to be displayed on the display 52 (step S2). A user inputs, for example, response action of consent (or acceptance) or refusal (cancel), etc. toward the message via the keyboard 54 (step S3). The response action is traced and monitored at the trace/action monitoring unit 26 (step S4).

The trace/action monitoring unit 26 traces delivery of the message including contents of a contract such as a contract and agreements and response action thereof. Based on detection thereof, the delivery and the action are stored as the trace data TD. The trace/action monitoring unit 26 sends the trace data TD to the authentication function unit 30 and the unit 30 executes authentication process thereof (step S5). The authentication data obtained from the authentication function unit 30 is returned to the trace/action monitoring unit 26 (step S6). Here, the authentication data is the trace data TD on which the hash value HN is tagged, that is, enciphered data of the trace data TD.

According to the authentication data, signature request is sent from the trace/action monitoring unit 26 to the signature server 12 (step S7). Signature process is executed at the signature server 12. The signed trace data sTD is returned to the trace/action monitoring unit 26 (step S8). The signed trace data sTD is stored in the signed data storage function unit 32 by storing process (step S9). In case the data has stored, storing completion notification is sent from the signature data storage function unit 32 to the trace/action monitoring unit 26 (step S10).

After such exchange, as for consent (or acceptance) or refusal (cancel) for/against a contract or agreements included in the message, a message is sent from the server 10 (step S11).

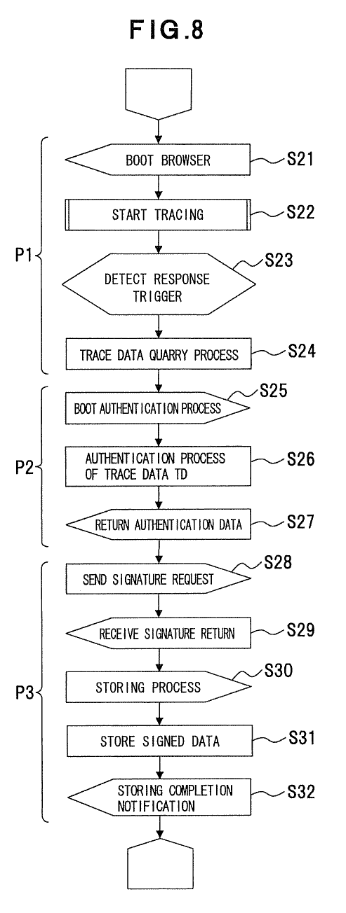

Process action of the communication terminal device will be described with reference to FIG. 8. FIG. 8 is a flowchart showing process action (a process program) of the cellular phone 4 in data process between the cellular phone 4, and the service provision server 10 and signature server 12.

A process program of this cellular phone 4 includes, a process of tracing and monitoring a message in response to browser booting (P1), a process of authentication of the trace data TD (P2) and a process of storing a signature and signed data (P3).

Process of Tracing and Monitoring a Message (P1)

To establish communication with the service provision server 10 to receive provided service, booting a browser of the cellular phone 4 is necessary. By booting the browser (step S21), trace is started (step S22). If an acceptance trigger (response trigger) as an example of response action in the message from the service provision server 10 is detected (step S23), a quarry process of the trace data TD from data traced and stored is executed (step S24). This quarry process of the trace data TD is a process, in response to detection of an acceptance trigger, extracting data within the predetermined time including an input time point of the acceptance trigger from traced continuous data as the trace data TD.

Process of Authentication of the Trace Data TD (P2)

If the trace data TD is generated, authentication process is booted (step S25). According to the trace data TD, the above described authentication process is executed (step S26). The authentication data is returned from the authentication function unit 30 to the trace/action monitoring unit 26 (step S27).

Process of Storing a Signature and Signed Data (P3)

If authentication data is generated, signature request is sent to the signature server 12 in response to the generation (step S28). After signature return corresponding to sending thereof is received from the signature server 12 (step S29), a storing process thereof is started (step S30). The signed data is stored in the signature data storage function unit 32 (step S31). Storing completion notification is sent (step S32) to and the process is completed.

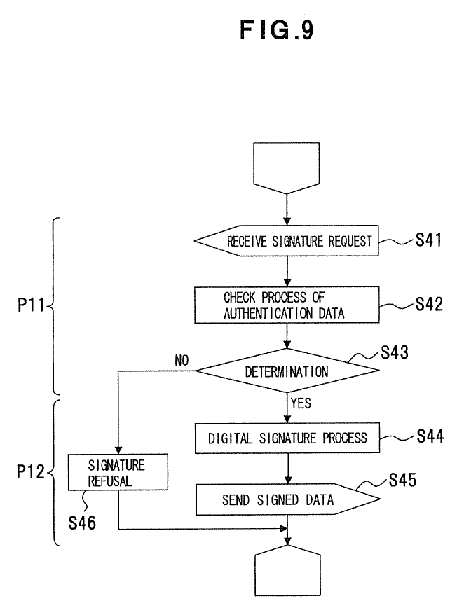

Process action of the server apparatus will be described with reference to FIG. 9. FIG. 9 is a flowchart showing process action (a processing program) of the signature server 12 in process action of the cellular phone 4 and the signature server 12.

A processing program of this signature server 12 includes a check process of authentication data (P1), signature process (P12), etc.

Check Process of Authentication Data (P11)

If the signature server 12 receives signature request (step S41), a check process of authentication data attached to the signature request is executed (step S42). As described above, the check process separates the hash value HN from the authentication data by the hash process and determines whether the trace data TD is falsified or not by comparing the hash value (step S43).

Signature Process (P12)

If the trace data TD is true (not falsified) (YES of step S43), a digital signature process is executed to the trace data TD and signed data is generated (step S44). To the cellular phone 4 that is a client of the signature request, the signed data is sent (step S45) and the process ends.

If the trace data TD is false (falsified) (NO of step S43), the digital signature process to the trace data TD is refused (step S46). To the cellular phone 4 that is a client of the signature request, the notification thereof is sent and the process ends.

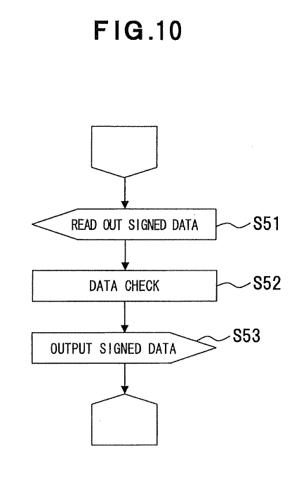

Process action of the communication terminal device (an extraction process of singed data) will be described with reference to FIG. 10. FIG. 10 is a flowchart showing process action (a processing program) of the cellular phone 4.

This processing program includes an extracting process of singed data stored in the cellular phone 4. In this case, if the cellular phone 4 is booted, reading out of signed data from a action menu displayed on the display operation unit 28 is instructed and certain singed data is selected, the signed data is read out from the signature data storage function unit 32 storing signed data (step S51). The signed data is checked in the data check function unit 34 (step S52). If being the selected singed data, the data is output from the cellular phone 4 (step S53) and the process ends.

Since singed data extracted from the cellular phone 4 can be stored in a recording medium and be presented as an image or printed output, the data can be provided as confirmation and authentication of contents of a contract, agreements or refusals of a user.

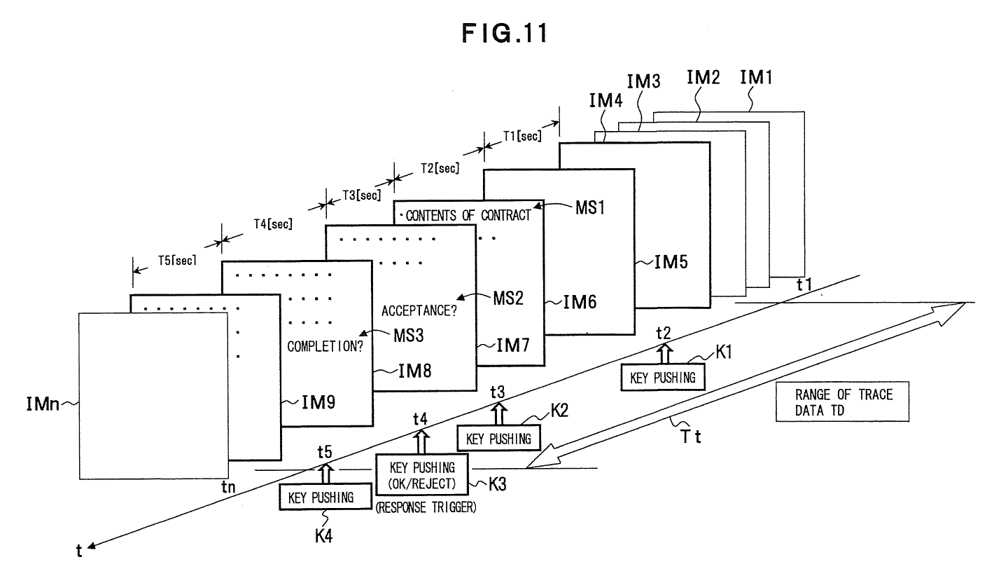

Response action to browser screen display of the communication terminal device (a tracing process of data) will be described with reference to FIG. 11. FIG. 11 depicts action of a data tracing process of the cellular phone 4.

According to the cellular phone 4, when a browser is booted, an image is displayed on the display 52 in the display operation unit 28 by image data delivered from the service provision server 10. If the image display is presented along a time axis t, a plurality of images IM1, IM2 . . . IMn exist continuously. A tracing process of data, as described above, starts at a booting time point of a browser t1 to continue until a booting stop time point of a browser tn.

According to such screen display, for example, an image IM6 displays “contents of a contract” as a message MS1 from the service provision server 10; an image IM7 displays “acceptance?” as a message MS2; and an image IM8 displays “complete?” as a message MS3. Without relationship with such contents of a display screen, for example, display time of an image IM4 T1 (sec), display time of an image IM5 T2 (sec) display time of the image IM6 T3 (sec), display time of the image IM7 T4 (sec) and display time of the image IM8 T5 (sec) are set.

Toward the displayed contents of the images IM4 to IM8, specific keys are input from the keyboard 54 of the display operation unit 28. For example, key pushing K1 is generated at a time point t2 with corresponding to the image IM4; key pushing K2 is generated at a time point t3 with corresponding to the image IM6; key pushing K3 is generated at a time point t4 with corresponding to the image IM7; and key pushing K4 is generated at a time point t5 with corresponding to the image IM8. These key pushing are traced to be stored as response action. At the key pushing K3 at the time point t4, acceptance (OK) or refusal (REJECT) is detected toward the contents of the display screen.

In response to these response triggers, the predetermined trace time Tt including the time points t2, t3, t4 and t5 of the response triggers is set as the range of object data. Data in the trace time Tt is quarried from all data D to be recorded as the trace data TD.

In the embodiment, since a plurality of the time points t2, t3, t4 and t5 exist, the trace time Tt is renewed to be prolonged. If a time point is only one, Tt becomes trace time including the time point.

In case of recording such trace data TD, by extending the time axis t, a plurality of images IM can be presented gently and be confirmed. That is, singed data of this trace data TD can display contents that cannot be confirmed because of short display time without relationship with intention of a service provider and can be confirmed.

Advantages of the above described embodiment are listed as follows.

(1) In case a contract and agreements are included in service provided from the service provision server 10, even if the contract or the agreements are displayed in an offer, the number of display is more or less one time. Moreover, if display time is short, confirming contents of a contract is difficult and even if there is difference between contents of a contract and intention of a user, it is difficult to confirm or authenticate the difference. According to the above described embodiment, the present invention can make good use of dissolution and reduction of such inconvenience.

(2) In case a contract and agreements are included in service provided from the service provision server 10, even if contents thereof are hidden or a program is falsified, for example, into displaying the contents as shortly or small as a user cannot recognize to make key pushing automatically to be consented to forcibly, the contents can be confirmed and authenticated afterward easily. In this case, to tag a signature function to authenticate that the stored or recorded trace data TD is not falsified but true to a network function helps prevention of foul play.

(3) Since data representing a contract and agreements of service and response action accompanying the contract and the agreements can be traced to be stored in the communication terminal device such as the cellular phone 4, and the trace data TD is allowed to be singed as true data at a network (communication corporation, etc.), the present invention can set off stopping an act such that a user is lead to a mistake.

(4) If configured by the trace data TD including response action of a user, the signed data can be used as countermeasures against unconscionable charge, etc.

(5) Since this data management system 2 quarries the trace data TD by using a browser function that has already existed to obtain authentication data, the ease and the reliability of data management or data process can be improved.

### Second Embodiment

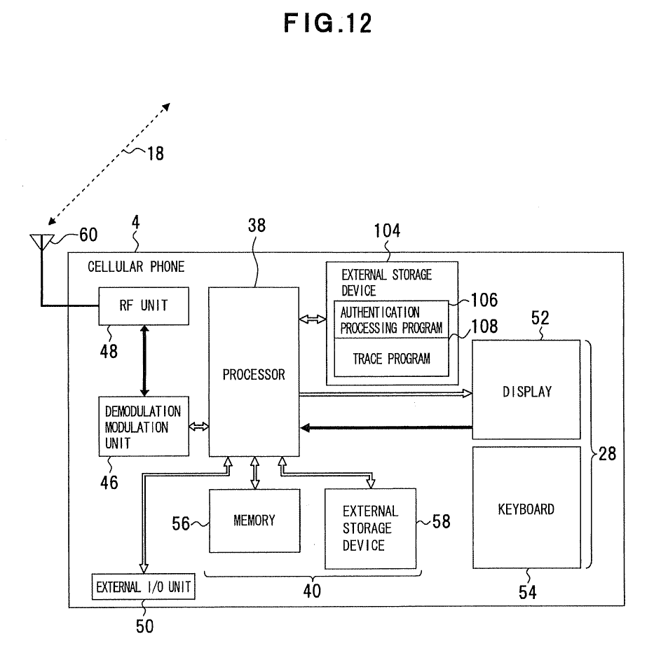

A second embodiment of the present invention will be described with reference to FIG. 12. FIG. 12 depicts an example of structure of a cellular phone according to the second embodiment.

In this second embodiment, the data management system 2 shown in FIG. 1 is used. According to the data management system 2, in the second embodiment, instead of the trace unit 42 and the authentication processing unit 44 of the cellular phone 4 (FIG. 3), an external storage device 104 is disposed. The external storage device 104 stores an authentication processing program 106 having a function of the authentication processing unit 44 and a trace program 108 having a function of the trace unit 42.

According to such structure, the processor 38 traces data by executing the trace program 108 in the external storage device 104. Authentication process of the trace data TD quarried from the data can be executed by the authentication processing program 106. Therefore, the same tracing and authentication process can be executed also by a software process.

### Third Embodiment

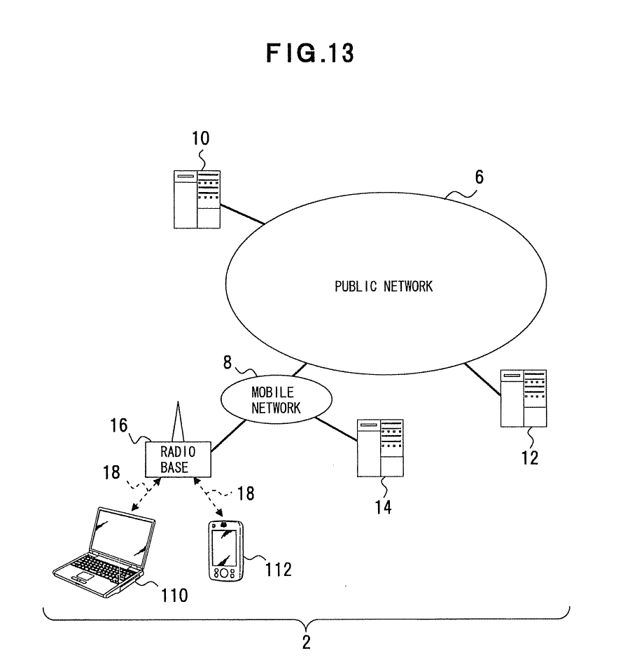

A third embodiment of the present invention will be described with reference to FIG. 13. FIG. 13 depicts a data management system according to a third embodiment.

In the first embodiment, the cellular phone 4 is exemplified as a communication terminal device. In this third embodiment, a notebook computer (PC) 110 and PDA (Personal Digital Assistant) 112 including a browser function are used to be structured. Such structure can obtain the above described trace data TD and can generate signed data.

### Fourth Embodiment

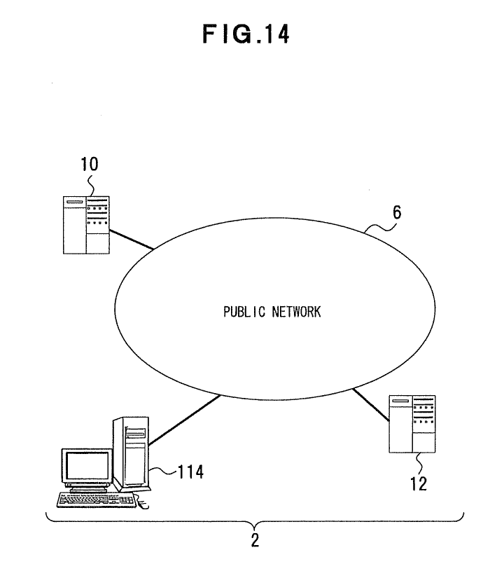

A fourth embodiment of the present invention will be described with reference to FIG. 14. FIG. 14 depicts a data management system according to a fourth embodiment.

The above described data management system 2 uses the mobile network 8. A personal computer (PC) 114 as a communication terminal device having a browser function may be connected directly to the public network 6.

By such structure, according to service provided from the service provision server 10 at PC 114, the above described trace data TD can be obtained and signed data can be generated.

While the present invention has been described with the preferred embodiments, the description is not intended to limit the present invention. Various modifications of the embodiments based on the subject matters and objects described in claims or disclosed in this specification will be apparent to those skilled in the techniques, and such modifications rightfully fall within the true scope of the present invention.

The present invention relates to data management of delivery data from a network and response action. To a message including a contract and agreements, since the message and response action thereof are traced and trace data is generated to be recorded, or a signature is tagged on the trace data and the trace data is recorded, the present invention can be provided as data management for recording, confirmation and authentication, etc.

What is claimed is:

1. A communication terminal device comprising:
a display unit that displays delivery data of a network on a screen;
an input unit that responds to the delivery data through a display screen on the display unit and generates response action thereof;
a processing unit that traces the delivery data from the network and the response action, and extracts the delivery data of predetermined time including a time point at which the response action generates and data representing the response action; and
a recording unit that records the data extracted by the processing unit.

2. The communication terminal device of claim 1, wherein
the data recorded in the recording unit includes one or more than one piece of the delivery data, displayed images on the display unit, contents of the response action and time data thereof.

3. The communication terminal device of claim 1, comprising:
a browser function that displays a browser display screen on the display unit.

4. The communication terminal device of claim 1, wherein
the response action is generated by key operation of the input unit.

5. The communication terminal device of claim 1, comprising:
an authentication function unit that generates authentication data by tagging private key data on the data obtained in the processing unit.

6. The communication terminal device of claim 1, comprising:
a signed data storage unit that stores signed data notified from a server apparatus via the network.

7. The communication terminal device of claim 1, comprising:
a signed data storage unit that stores signed data notified from a server apparatus generating the signed data with tagging a signature on the data; and
a check function unit that checks the signed data read out from the signed data storage unit and outputs the signed data.

8. The communication terminal device of claim 7, wherein
the signed data is enciphered with tagging key data and the signed data is checked by using the key data.

9. A server apparatus that is connected with a communication terminal device via a network, the server apparatus comprising:
an authentication function unit that authenticates whether data sent from the communication terminal device is true or not; and
a signature function unit that tags a signature on the data in case where the data is true.

10. The server apparatus of claim 9, wherein
the authentication function unit authenticates whether the data is true or not by using private key data; the data which is sent from the communication terminal device that transmits the data with tagging the private key data.

11. The server apparatus of claim 9, wherein
the signature function unit tags key data on the data sent from the communication terminal device, and generates signed date with a signature.

12. A data management method comprising the process of:
displaying delivery data of a network on a screen;
responding the delivery data and generating response action thereof;
tracing the delivery data from the network and the response action, and extracting the delivery data within predetermined time including a time point at which the response action generates and data representing the response action; and
recording the data.

13. The data management method of claim 12, comprising the process of:
generating authentication data by tagging private key data on the data.

14. The data management method of claim 12, comprising the process of:
storing signed data notified from a server apparatus via the network.

15. The data management method of claim 12, comprising the process of:
storing signed data notified from a server apparatus generating the signed data with tagging a signature on the data; and
reading out the signed data from a storing destination and after checking the signed data, outputting the signed data.

16. A computer-readable recording medium storing a data management program, the program comprising the steps of:
displaying delivery data of a network on a screen;
responding the delivery data and generating response action thereof;
tracing the delivery data from the network and the response action, and extracting the delivery data for predetermined time including a time point at which the response action generates and data representing the response action; and
recording the data.

17. The recording medium of claim 16, the program comprising the step of:
generating authentication data by tagging private key data on the data.

18. The recording medium of claim 16, the program comprising the step of:
storing signed data notified from a server apparatus via the network.

19. The recording medium of claim 16, the program comprising the step of:
storing signed data notified from a server apparatus generating the signed data with tagging a signature on the data; and
reading out the signed data from a storing destination and after checking the signed data, outputting the signed data.
